(19) United States
(12) Patent Application Publication
(10) Pub. No.: US 2025/0200130 A1
(43) Pub. Date: Jun. 19, 2025

(54) FLOW NETWORK INTERMEDIATE REPRESENTATION FOR OPTIMIZATION PROBLEMS

(71) Applicant: MICROSOFT TECHNOLOGY LICENSING, LLC, Redmond, WA (US)

(72) Inventors: Behnaz ARZANI, Woodinville, WA (US); Ryan Andrew BECKETT, Seattle, WA (US); Siva Kesava Reddy KAKARLA, Redmond, WA (US); Solal Vincenzo PIRELLI, Lausanne (CH); Santiago M. SEGARRA, Houston, TX (US); Pooria NAMYAR, Los Angeles, CA (US)

(21) Appl. No.: 18/934,049

(22) Filed: Oct. 31, 2024

Related U.S. Application Data
(60) Provisional application No. 63/612,360, filed on Dec. 19, 2023.

(51) Int. Cl. G06F 17/11

(52) U.S. Cl. CPC G06F 17/11

(57) ABSTRACT

A heuristic that solves an optimization problem is analyzed to determine how and why it underperforms a benchmark solution. A novel intermediate representation (IR) is used to construct a network flow graph that models the optimization problem. Solutions to the optimization problem are defined programmatically with reference to the network flow graph. A compiler translates the programmatic definitions of the heuristic and a benchmark solution to a low-level model of constraints and objectives. A heuristic analyzer iteratively analyzes the constraints and objectives to identify inputs that cause the heuristic to yield inefficient results relative to the benchmark. Properties of inputs and properties of the heuristic that cause the heuristic to underperform are identified, and an explanation of when, how, and why the heuristic underperforms is generated.

### CLAIM OF PRIORITY

This application claims the benefit of and priority to U.S. Provisional Application No. 63/612,360, filed Dec. 19, 2023, which is herein incorporated by reference in its entirety.

### BACKGROUND

Heuristics are often used to solve optimization problems. For example, a heuristic may be used by a cloud operator to allocate virtual machines among physical servers. Heuristics take significantly less time to execute than optimal algorithms. However, the resource being optimized is often not utilized efficiently. Continuing the example, a virtual machine allocation heuristic may leave servers with unused capacity. It is not uncommon for resource utilization of some heuristics to be half that of an optimal algorithm, meaning it may require twice as many resources or twice as much time to achieve the same outcome. Existing tools for analyzing why heuristics underperform are limited to finding concrete symptoms, but are not able to determine the root causes that explain the issue. This makes it difficult to fundamentally fix a heuristic or systematically prevent bad outcomes.

It is with respect to these and other considerations that the disclosure made herein is presented.

### SUMMARY

A heuristic that solves an optimization problem is analyzed to determine how and why it underperforms a benchmark solution. A novel intermediate representation (IR) is used to construct a network flow graph that models the optimization problem. Solutions to the optimization problem are defined programmatically with reference to the network flow graph. A compiler translates the programmatic definitions of the heuristic and a benchmark solution to a low-level model of constraints and objectives. A heuristic analyzer iteratively analyzes the constraints and objectives to identify inputs that cause the heuristic to yield inefficient results relative to the benchmark. Properties of inputs and properties of the heuristic that cause the heuristic to underperform are identified, and an explanation of when, how, and why the heuristic underperforms is generated.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates heuristic performance gap identification and explanation.

FIG. 2 illustrates a heuristic analysis engine.

FIG. 3 illustrates generating a gap explanation.

FIG. 4 illustrates a traffic engineering diagram.

FIG. 5A illustrates a network flow graph of the traffic engineering problem.

FIG. 5B illustrates a heatmap of a heuristic.

FIG. 5C illustrates a heatmap of a benchmark solution.

FIG. 6 is a flow diagram of an example method for flow network intermediate representation for optimization problems.

FIG. 7 is a computer architecture diagram illustrating an illustrative computer hardware and software architecture for a computing system capable of implementing aspects of the techniques and technologies presented herein.

### DETAILED DESCRIPTION

Existing techniques identify inputs to an optimization problem that cause a heuristic to underperform. While useful, this information does not indicate how to fix the heuristic. The disclosed configurations build on this functionality to identify what choices cause a heuristic to perform poorly, the properties of inputs that trigger these choices, and why the identified properties trigger the identified choices.

One motivating example is how cloud operators allocate requests for virtual machines to physical servers. Each physical server can support a number of virtual machines based on the capacity of the physical server and the resource demands of the virtual machines. Cloud operators seek to minimize the number of servers in use at a given time. Failure to do so could result in wasting billions of dollars over-provisioning data centers and consuming inordinate amounts of electricity. When capacity limits are reached, an inefficient allocation of virtual machines to physical servers may result in ceding business to a competitor.

While cloud operators are motivated to improve the efficiency of virtual machine allocation, they are also constrained by how long it takes to allocate a VM—customers are unwilling to wait more than a few minutes for their VM to be allocated. Cloud operators are also conscious of the resources and energy costs of computing how to allocate resources. Accordingly, cloud operators often employ heuristics to quickly and efficiently allocate VMs to physical servers.

Allocating virtual machines to physical servers is an example of the vector bin packing problem. The vector bin packing problem arranges items of different sizes into a fixed number of bins, minimizing the number of bins used. Under this rubric, physical servers are bins and virtual machines are items assigned to the bins. Specifically, cloud operators “pack” VMs onto servers based on memory and processing requirements of the requested VMs and the capacity of the physical servers. The vector bin packing problem is computationally hard-optimal algorithms may take hours to complete. This makes optimal algorithms inappropriate for real-time VM allocation, and so heuristics are used instead.

One heuristic for the bin packing problem—“first fit”—places each VM on the first available server that can handle it. Running this heuristic takes very little time, but it may allocate 1.5 times as many physical servers as an optimal algorithm. As a simplified example, assume that VMs require processing resources and nothing else, and that all physical servers have the same amount of processing power. Incoming VMs request 40%, 40%, 60%, and 60% of processing capacity, in that order. “First fit” assigns the first two VMs to a single server, allocating 80% of that server's processing capacity. The next two 60% VMs are each allocated to a different server, such that a total of 3 servers are allocated. This is 50% more than the optimal allocation, which assigns two servers each a 40% and a 60% VM.

Existing analysis tools may uncover individual scenarios that result in these inefficiencies, but existing techniques do not provide a deeper understanding as to why “first fit” fails in this instance. Operators are left to stare at examples of inefficient allocation to see if they can understand why first fit under-performs, and how to change the choices it makes to improve performance. This requires a significant amount of time and expertise, and the lessons learned from analyzing one heuristic do not always generalize to other heuristics or other optimization problems. This difficulty is compounded when considering more complex problems in which bins have multiple dimensions of capacity, such as server processing power and memory capacity. Other heuristics for the vector bin packing problem may provide a better execution speed to allocation efficiency trade-off, but are even more complex and difficult to reason about.

Many other tasks utilize heuristics to quickly approximate good solutions to optimization problems. Packet scheduling, traffic engineering, job scheduling, and congestion control are a few examples of computationally hard problems that cloud computing operators use heuristics to solve. Optimization problems are also used for route planning, ride-sharing allocation, factory production scheduling, staff scheduling, energy grid management, etc. The techniques disclosed herein may be applied to heuristics that solve these and other problems.

Explaining why a heuristic under-performs is challenging. Optimization problems are typically analyzed with low-level “solver” software that can solve linear convex optimization problems. Creating and understanding low-level models that are compatible with solvers is challenging, even for experienced professionals. Typically, low-level model creation requires expertise in formal methods or optimization theory. Furthermore, low-level models operate over variables and constructs that are hard to connect to the original problem, making it difficult to derive easy-to-read explanations.

To address these issues, disclosed is a novel intermediate representation (IR) usable to model and analyze solutions to optimization problems. First, the optimization problem itself is modeled by constructing a network flow graph with IR nodes connected by directed arcs. Analyzing how flow moves through the graph solves the optimization problem.

Solutions to the optimization problem—heuristics, optimal solutions, and other benchmarks—are modeled by programmatically defining how flow passes through “Choice Nodes” of the graph. A solution's choices become constraints that restrict flow through the graph.

The disclosed IR enables heuristics to be modeled at a higher level of abstraction and with an order of magnitude less code than directly encoding them in low-level, solver-compatible models. The disclosed IR is able to represent the most common heuristics and can be customized to support additional algorithms. The disclosed IR allows the heuristic's decisions to be defined and performance gaps to be explained in terms of the optimization problem's semantics. This allows explanations for underperformance to be identified and expressed in terms that are relatable to the heuristic designer. At the same time, the low-level queries generated from the IR typically execute as quickly as hand-crafted low-level code.

A compiler translates a heuristic and a benchmark into a low-level, heuristic-analyzer-compatible representation. A heuristic analyzer may perform a bi-level optimization of the two solutions to find an input that causes the heuristic to underperform the benchmark.

However, merely identifying a particular underperforming input does not identify a property of the input or a property of the heuristic that is causing the performance gap. To explain why the heuristic underperforms, the heuristic analyzer is iteratively invoked to identify a collection of inputs that cause the heuristic to underperform. This collection of inputs is analyzed to determine different choices made by the heuristic as compared to the benchmark, arcs that are predominantly taken by the heuristic or the benchmark, and/or properties of inputs that lead to these differences.

Explaining why a heuristic under-performs entails determining (1) which of its decisions cause it to underperform and (2) what about the inputs causes the heuristic to make those decisions. (1) allows heuristic designers to change the decisions the heuristic makes to avoid poor performance. (2) allows an operator to change which heuristic is used, improving performance. For example, if a certain class of inputs tends to cause problems for a heuristic that otherwise performs well, an operator may choose to switch to a different heuristic for that class of input. Even if this other heuristic takes longer to execute, the improvement in the efficiency of the results it generates may be worth it.

Existing heuristic analyzers alone are not able to make these determinations. Existing heuristic analyzers require that a heuristic is expressed as a Satisfiability Modulo Theory (SMT), feasibility constraints, or convex problem. These analyzers then feed these low-level models into a solver such as Z3 or Gurobi. Cloud service operators are usually not experts in optimization theory or low-level SMT, and are prone to creating inefficient models that take the heuristic analyzer a long time to analyze. More importantly, these low-level models operate over abstract variables which are often not directly connected to the heuristic and its decisions. This makes it hard to derive human-readable explanations.

The collection of inputs that cause the heuristic to underperform are analyzed to identify a condition that detects gap-causing inputs. In some configurations, enumerative synthesis is used to randomly or semi-randomly combine input variables into a variety of candidate conditions. The candidate conditions are then evaluated to identify a condition that reliably detects gap-causing inputs. For example, if an algorithm has numeric input values, many variations of numeric comparisons between the input values may be tried in order to identify a condition that evaluates to true for at least a defined percentage of gap-causing inputs. Conditions found to correlate with efficiency gaps are then reported, explaining to operators what it is about the inputs that cause efficiency gaps. Explaining the conditions under which efficiency gaps occur may provide insight to an operator seeking to improve the heuristic.

Another technique for explaining gaps between a heuristic and a benchmark identifies different flow graph choices made by the different solutions. In some configurations, multiple samples of inputs are evaluated for both solutions. The arcs taken by the different solutions create heat maps. Arcs that are predominantly taken by one of the solutions but not the other reveal different choices made by the solutions. In this way, gap-producing inputs identified by a low-level heuristic analyzer can be used to identify higher-level choices of the heuristic that are responsible for underperformance.

The inputs used to generate the heat map may be selected at random. Additionally, or alternatively, an initial input that causes a performance gap may be identified as discussed above. Additional inputs may be selected based on the initial input. For example, when an initial input value is numeric, additional input values may be randomly selected from a defined distance of the initial input value. In some configurations, multiple initial inputs may be used to find a broader distribution of additional proximate inputs.

Explanations can be generated based on the heat map. In some configurations an LLM may be used to summarize the differences, expressing where choices of the heuristic deviated from those of the benchmark. For example, the summary may identify a choice node of the network flow graph that the heuristic treated differently than the benchmark. The efficiency gap explanation may also indicate patterns or ranges of input values that caused the divergences between the two solutions. In some configurations, user-generated metadata that is associated with arcs and/or nodes of the network flow graph may be included in the explanation.

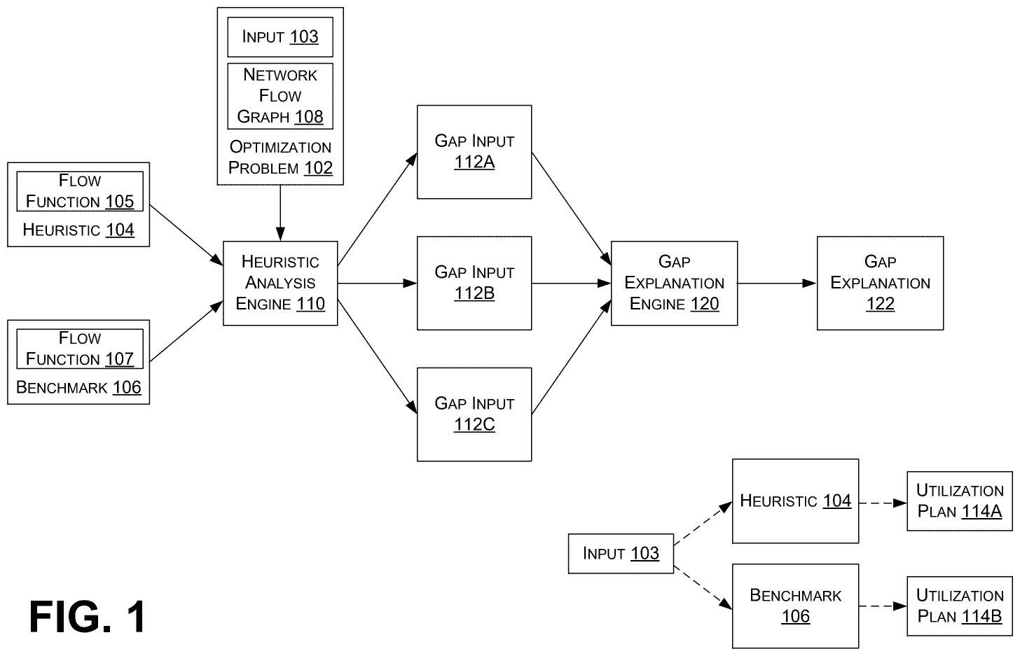

FIG. 1 illustrates heuristic performance gap identification and explanation. Heuristic analysis engine 110 identifies gaps in efficiency between two solutions to optimization problem 102. An optimization problem finds the best solution from a set of feasible alternatives based on a defined objective or criteria. One example of an optimization problem is traffic engineering, which adjusts network configurations or resource allocations to optimize parameters like latency, throughput, or network capacity while satisfying constraints like bandwidth limits or routing policies.

Heuristic 104 and benchmark solution 106 are examples of solutions to optimization problem 102. Heuristic 104 is constrained from considering all possible solutions, thereby allowing optimization problem 102 to be solved in less time or with fewer resources. However, these constraints also prevent identification of an optimal solution. Benchmark 106 refers to a solution to optimization problem 102 that heuristic 104 is compared against. Benchmark 106 may be an optimal solution or another heuristic. Some optimization problems have optimal solutions that are exponentially complex, requiring an inordinate amount of time to solve. This is one reason operators may prefer to use a heuristic that finds a good-enough solution in a reasonable amount of time.

Optimization problem 102 is modeled with a network flow graph 108. Network flow graph 108 may be constructed with the disclosed intermediate representation (IR). IR nodes define the possible ways that a solution may route flow from sources to sinks of network flow graph 108. For example, a solution may define how a pick node selects which outgoing arc will receive all of that node's flow. Heuristics and optimal solutions or other benchmark solutions may be modeled for an optimization problem with these techniques.

The network flow graph that represents the optimization problem may be constructed with pre-defined IR nodes that have predefined constraints and objectives. Source nodes represent inputs to the optimization problem. For example, when allocating virtual machines among physical servers, source nodes may represent the requested VM sizes or the remaining capacity of physical servers. Choice nodes represent decisions that the heuristic makes. For example, a pick node sends incoming flow to one and only one outgoing arc based on a condition. Sink nodes encode objectives, which represent the goals of the optimization problem. Heuristic analysis engine 110 translates choices made by heuristic 104 into flow conservation rules that restrict how flow moves through the network flow graph. Optimization problem 102 may be modeled programmatically, declaratively, visually, etc.

Operators or other users are also able to define custom nodes with custom constraints and objectives. Custom nodes define how their constraints and objectives are translated to a low-level representation used by heuristic analyzers. Few restrictions are placed on the constraints and objectives of a custom node, apart from requiring that they can be formulated either as a convex optimization problem or a feasibility problem that is compatible with the solver.

Metadata assigned to nodes or arcs of a network flow graph may be defined with expressions that follow a defined grammar. While many grammars or other constructs may be used, what follows is one non-limiting example. Attributes added to nodes or arcs of network flow graph 108 may be reference by a flow function that programmatically defines a solution to optimization problem 102. Additionally, or alternatively, attributes added to nodes or arcs of network flow graph 108 may be used to generate an explanation for conditions under which heuristic 104 underperforms benchmark 106:

```
Attribute Value := Arc[String]
      | Real
      | ...standard math on Attribute Values...
AttributeOp := == | != | <= | < | >= | >
AttributeComparison := (AttributeValue,
        AttributeOp,
        AttributeValue)
LinearValue := AttributeValue * Var
      | AttributeValue
      | LinearValue + LinearValue
LinearOp := == | <= | >=
LinearComparison := (LinearValue,
        LinearOp,
        Linear Value)
Comparison := LinearComparison
      | AttributeComparison
      | Comparison && Comparison
      | Comparison || Comparison
```

In this grammar, “Attribute Value” may be one of three things: “Arc [String]”, “Real”, or recursively, a mathematical operation applied to two or more Attribute Values. “Arc” refers to an arc that connects two nodes of network flow graph 108. “String” refers to text and “Real” refers to a real number. “Arc [String]” refers to an arc identified by a string.

AttributeOp refers to standard mathematical comparison operations. “==” means “equal to”. “!=” means “not equal to”. “<=” means “less than or equal to”. “<” means “less than”. “>=” means “greater than or equal to”. “>” means “greater than”.

AttributeComparison refers to a comparison between two AttributeValues. Specifically, AttributeComparison is defined as a triple of (value1, comparison_operator, value2), such that comparison_operator is applied to value1 and value2.

Linear Value may refer to multiplying an attribute value by a variable, an attribute value by itself, or, recursively, the sum of two linear values. LinearOp refers to one of three comparisons, while LinearComparison is a triple that uses a LinearOp to compare two LinearValues.

Comparison refers to a linear comparison, an attribute comparison, or, recursively, a Boolean combination of two Comparisons. As illustrated Boolean ‘and’ and Boolean ‘or’ are listed, but other Boolean operators are similarly contemplated.

Analyzing how flow traverses network flow graph 108 solves optimization problem 102 for input 103. Solutions to optimization problem 102 accept input 103 and output a configuration or utilization plan 105 for resources being optimized. Input 103 may include any number and type of variables, such as integer values, continuous numeric values, text, etc.

Heuristic 104 and benchmark 106 are defined programmatically with reference to the intermediate representation (IR) that defines optimization problem 102. Specifically, flow function 105 is invoked for each choice node of network flow graph 108 to generate a low-level representation of heuristic 104. Similarly, flow function 107 is invoked for each choice node of network flow graph 108 to generate a low-level representation of benchmark 106.

Each invocation of a flow function determines the percentage of flow assigned to each outgoing arc of that particular node. A flow function may access intrinsic functions that return information about the particular node and associated arcs. For example, “IncomingFlow” returns the amount of flow that is incoming to a particular node, “AvailableCapacity” returns how much capacity is available to a particular arc, and “OutgoingArcs” returns a list of arcs leaving the particular node.

In some configurations, nodes of network flow graph 108 are evaluated by a flow function in a particular order. For example, a weight function may be invoked on the choice nodes of network flow graph 108 to define an order in which nodes of the network flow graph 108.

In some configurations, flow function 105 is defined with software code. The code that defines flow function 105 may translate high level flow assignment to low level constraints and objectives that are compatible with a heuristic analyzer or other solver. While flow function 105 may be defined with any programming language or any programming style, one example embodiment enables query expressions to be run over arc sequences while assigning flow to outgoing arcs. Examples of query expressions are “select”, which applies a function to each element of an arc sequence and returns a mapping of arcs to values generated by the function. A “where” query filters a list of arc sequences based on a supplied condition, returning an arc sequence of arcs that satisfy the filter. Some query expressions find a particular value within an arc sequence, such as “max” and “min”, while others aggregate something about the arc sequences, such as “sum”. “Count” identifies how many elements are in an arc sequence, while “take” returns a defined number of arcs as an arc sequence. Query expressions such as these may be used in conjunction with the intrinsic functions mentioned above to assign network flow to a choice node of network flow graph 108.

For example, a heuristic that implements demand pinning for a demand threshold T may use the IncomingFlow heuristic to obtain the demand for a given node. It may then use the OutgoingArcs intrinsic to obtain a sequence of outgoing arcs of the given node, and apply the “min” query that finds the outgoing arc with the shortest path length. In some configurations, path length is an attribute assigned by the network flow graph creator and is accessed by passing the “min” query an expression that accesses the “PathLength” attribute. Then, with the incoming demand and the shortest outgoing path computed, a “where” query may be applied to select outgoing arcs that have a path length equal to the shortest path, while also ensuring that the incoming flow is less than the threshold demand. A “take” query may be applied to the output of the “where” query to select a single outgoing arc, removing any ambiguity by the existence of multiple shortest paths. Finally, a “select” query may be applied to assign all of the flow to the outgoing arc returned by the “take” query.

While assigning flow, heuristic 105 sees the flow assignments they have already made and zero for nodes not yet handled. This enables techniques like summing the incoming flow of an arc's target node to determine remaining capacity. In some configurations, heuristic 105 may maintain state across nodes. For example, a Least Recently Used (LRU) caching heuristic keeps track of previous cache requests. In some configurations, if heuristic 105 requests impossible flow (e.g., more flow than available or multiple arcs for a “pick” node), heuristic analysis engine 110 will notify the user. However, if heuristic 105 is not generally feasible, but happens to work for a specific problem instance, heuristic analysis engine 110 may not flag it as infeasible.

Heuristic analysis engine 110 analyzes heuristic 104 and benchmark solution 106 to identify gap inputs 112. Gap inputs 112 are inputs to optimization problem 102 that cause heuristic 104 to yield an inefficient result—i.e., cause an inefficient utilization plan 114A compared to utilization plan 114B. For example, input 103 may include four numeric inputs, x1, x2, x3, and x4, which range in value from zero to one hundred. Gap input 112A may indicate that the values {1, 3, 98, 20} cause heuristic 104 to generate an inefficient utilization plan 114A. Similarly, an analysis may determine that a performance gap is observed when the sum of all inputs is greater than a particular constant value, or when a particular input is within a defined percentage of a maximum value. In some configurations, heuristic 104 is determined to be inefficient when utilization plan 114A is at least a defined percentage less efficient that utilization plan 114B.

When heuristic analyzer 110 identifies gap inputs 112 that lead to a performance gap, there is at first no obvious relationship among gap inputs 112. Furthermore, it is not intuitive what it is about gap inputs 112 that causes the inefficiency. Moreover, there is no immediate connection between gap inputs 112 that heuristic analyzer engine 110 has identified and user-created network flow graph 108.

In some configurations, gap inputs 112 are fed through the network flow graph 108 to generate heat maps. Specifically, gap explanation engine 120 analyzes gap inputs 112 to produce gap explanation 122. In some configurations, gap explanation engine 120 invokes heuristic 104 with gap inputs 112, each time noting which arcs of network flow graph 108 were taken. Gap explanation engine 120 may similarly invoke benchmark 106 with gap inputs 112, again noting which arcs of network flow graph 108 were taken. This information is aggregated into a heat map that pinpoints different arcs taken by the different solutions. Arcs that are predominantly or exclusively taken by one solution but not the other reveal different choices made by the different solutions. Gap explanation engine 120 may use this information to generate gap explanation 122, which explains how heuristic 104 differs from benchmark 106 and which gap inputs 112 trigger these differences.

Additionally, or alternatively, gap explanation 122 includes patterns identified in gap inputs 112. In some configurations, enumerative synthesis is used to try many different expressions that reference input 103. For example, if input 103 has multiple numeric input values, many variations of comparisons between the input values may be evaluated to identify a set of comparisons that evaluate to true for at least a defined percentage of gap inputs 112. Expressions of inputs found to correlate with gaps are then reported. By presenting the conditions under which gaps occur, a user is better equipped to improve heuristic 104. The conditions under which gaps occur may also be used to selectively use or not use particular heuristics. For example, a heuristic that works well over a wide range of inputs may be used as a default, but replaced for inputs that likely cause the heuristic to significantly underperform an alternative solution.

Explanations can be generated based on the heat map. In some configurations an LLM may be used to summarize the differences, expressing which choices of heuristic 104 deviated from those of the benchmark 106. In some configurations, user-generated metadata may be used to generate the explanation. For example, a metadata description of an arc may be included in the explanation.

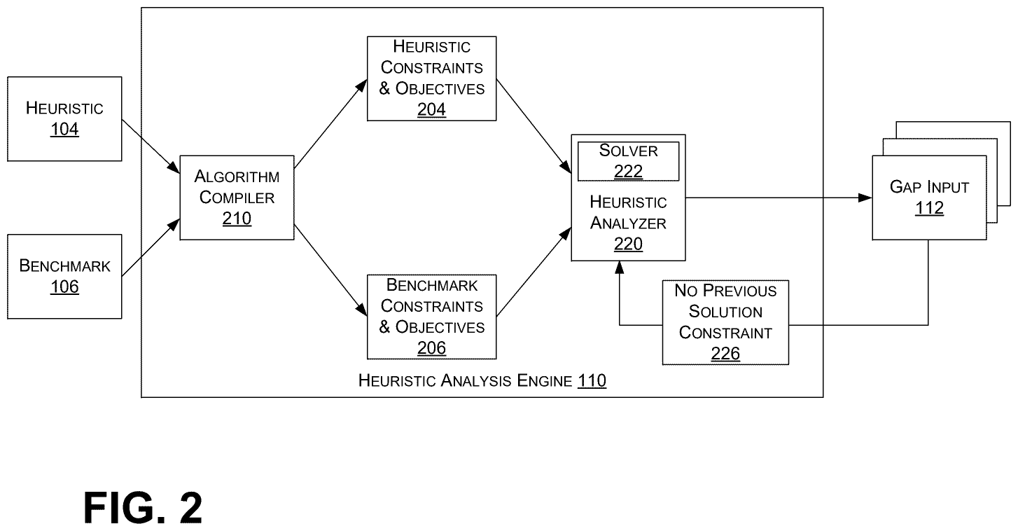

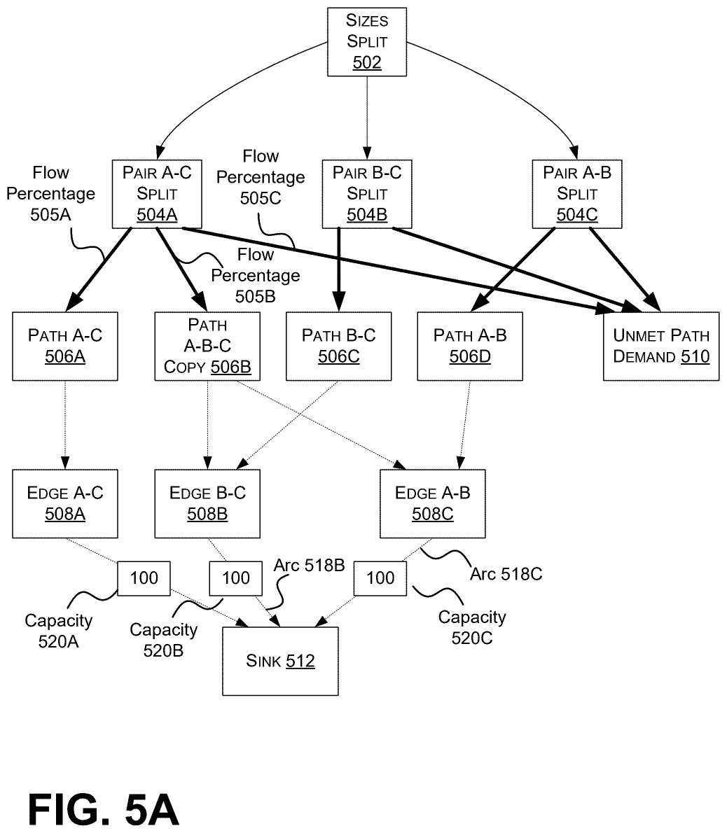

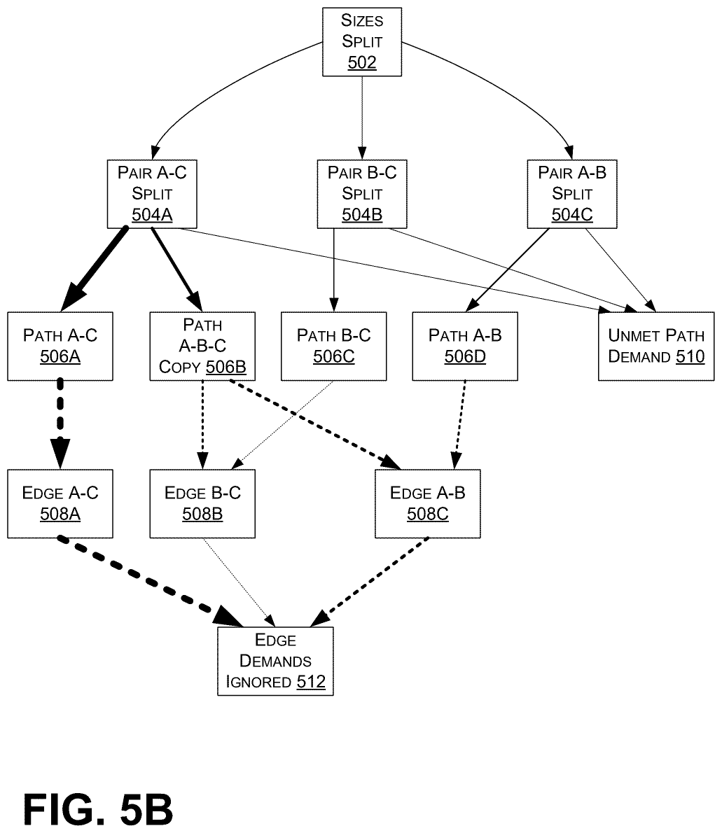

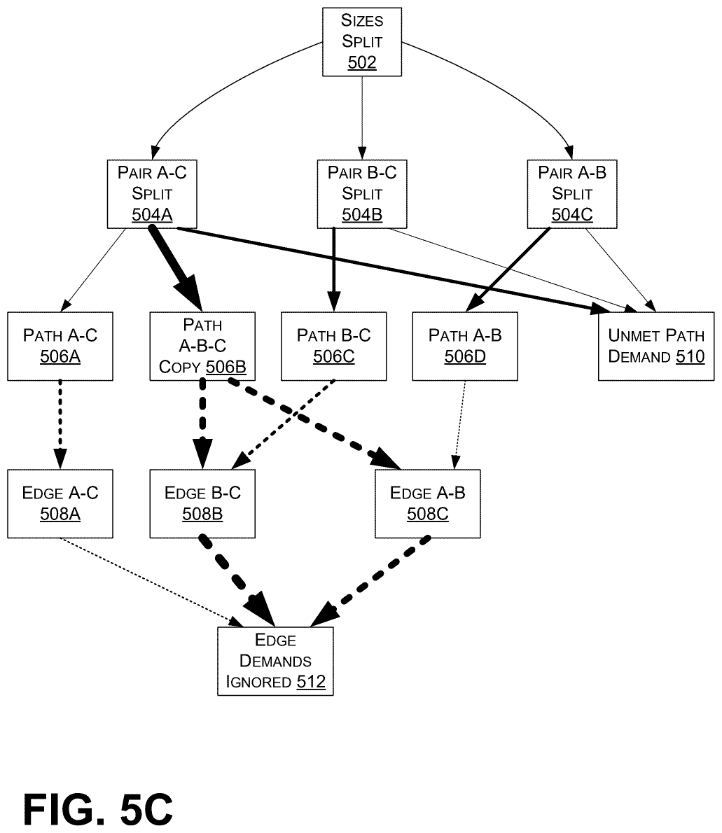

FIG. 2 illustrates a heuristic analysis engine. Heuristic analysis engine 110 receives heuristic 104 and benchmark 106. As discussed in more detail below in conjunction with FIG. 5A, heuristic 104 and benchmark 106 are programmatic descriptions of how flow should be directed through the network flow graph representation 108 of optimization problem 102.

Algorithm compiler 210 translates heuristic 104 and benchmark 106 into constraints and objectives that are compatible with heuristic analyzer 220. Specifically, heuristic 104 is translated into heuristic constraints and objectives 204 while benchmark 106 is translated into benchmark constraints and objectives 206. In this context, constraints refer to limitations placed on choice nodes that define how flow is directed through network flow graph 108. Limiting the choices made by a solution to an optimization problem simplifies the problem, reducing the amount of time and/or resources needed to solve it, while at the same time limiting the ability of the heuristic to determine an optimal solution.

In some configurations, compilation turns every arc of a network flow graph into a variable. Flow conservation rules are then enforced on these variables. Objective functions are created from sink objectives of the network flow graph. In some configurations, in order to reduce the number of variables needed to represent the heuristic, arcs from output nodes can be defined in terms of input and choice nodes. This reduces the number of variables in the compiled query.

Heuristic analyzer 220 identifies gap input 112 by applying a bi-level optimization of heuristic constraints and objectives 204 and benchmark constraints and objectives 206. In some configurations, heuristic analyzer 220 models the bi-level optimization of the constraints and objectives 204 and 206 as a convex optimization problem compatible with solver 222. Heuristic analyzer 220 may inject an additional constraint that requires inputs 103 remain the same for heuristic 104 and benchmark 106, ensuring that a fair comparison is made between the two solutions. Solver 222 solves the convex optimization problem to identify gap input 112.

A bi-level optimization is a hierarchical optimization problem with two interconnected levels. Typically, the solution to the ‘outer’ problem depends on the outcome of the ‘inner’ problem. In this context, the outer problem is to find inputs that maximize the gap between the heuristic and the benchmark, while the inner problem is for the heuristic and the benchmark to independently find optimal solutions to the optimization problem. Heuristic analyzer 220 adds a constraint that ensures the inputs remain the same for both solutions in order to make sure that heuristic 104 and benchmark 106 solve the same problem.

Often the outer and the inner problems have competing interests. In this context, while the outer problem attempts to increase the performance gap, the inner problem seeks to reduce the gap indirectly by optimizing how heuristic 104 and benchmark 106 solve optimization problem 102. This interplay between the outer and inner problems makes the task of identifying significant performance gaps particularly complex. One example of a heuristic analyzer that may be used is METAOPT. METAOPT supports a well-defined set of heuristics that can be posed as a convex optimization or a feasibility problem.

In some configurations, Heuristic analysis engine 110 iteratively invokes heuristic analyzer 220 to generate multiple gap inputs 112. In some configurations, for each iteration, a no previous solution constraint 226 is added to exclude previously identified gap inputs 112 from being identified a second time. In some configurations, no previous solution constraint 226 excludes specific gap inputs 112, while in other configurations ranges of inputs proximate to previously identified gap inputs 112 are excluded. Excluding ranges of inputs ensures that that gap inputs 112 are identified from a variety sub-spaces of input 103.

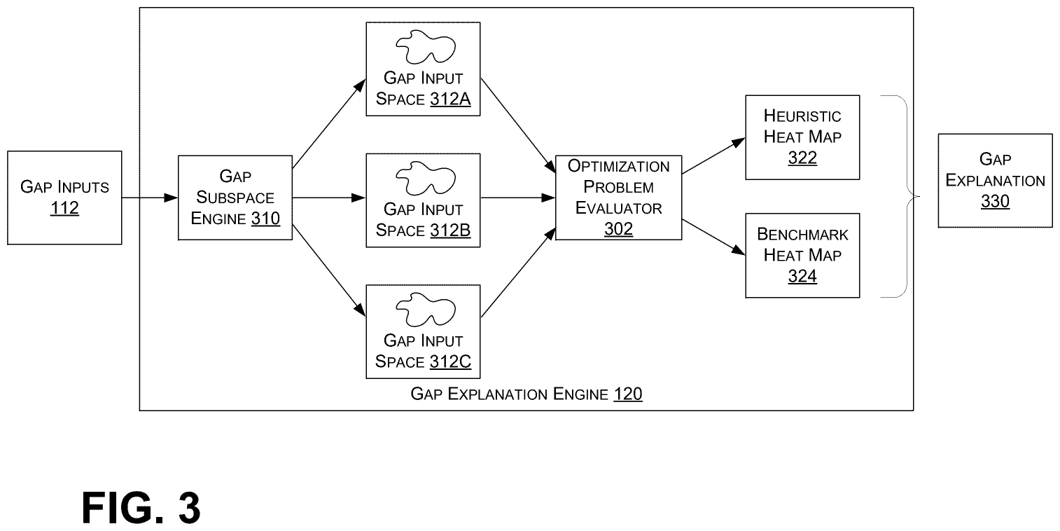

FIG. 3 illustrates generating a gap explanation. Gap inputs 112 produced by heuristic analysis engine 110 are received by gap explanation engine 120. In some configurations, gap subspace engine 310 generates gap input spaces 312 from individual gap inputs 112. Gap input spaces 312 represent ranges of inputs that are proximate to gap inputs 112. Gap input spaces may be selected at random within a defined distance of gap inputs 112. For example, when gap inputs 112 represent numeric values, a gap input spaces may be defined as input values within a defined Euclidian distance of a gap input 112.

Optimization problem evaluator 302 selects inputs from gap input spaces 312 and uses the to evaluate heuristic 104 and benchmark 106, tallying which arcs of network flow graph are taken by the different solutions. The tallies of arcs taken by heuristic 104 make up heuristic heat map 322, while the tallies of arcs taken by benchmark 106 make up benchmark heat map 324.

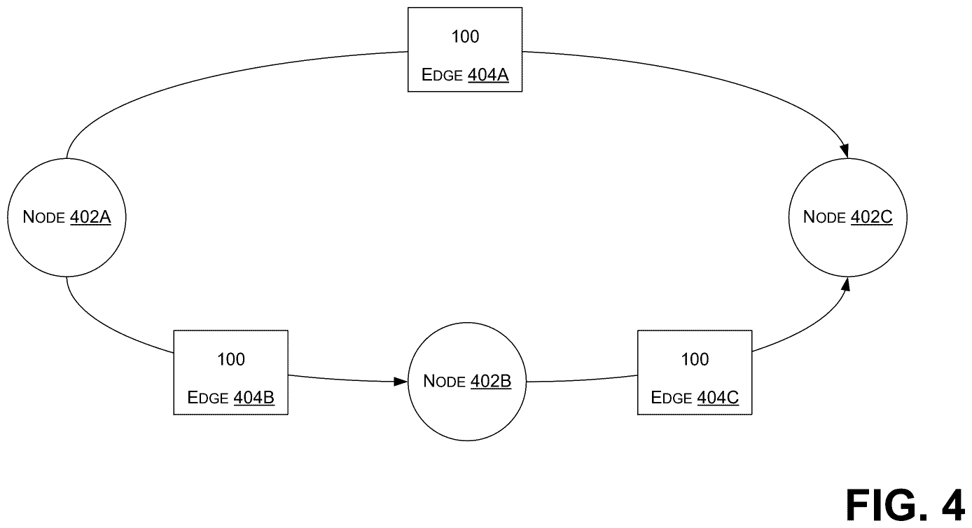

FIG. 4 illustrates a traffic engineering diagram. In this simplified example, there are three computing devices: node 402A, node 402B, and node 402C. These nodes represent computing devices that are connected by a network, such that device 402A is connected to device 402C directly by edge 404A, device 402A is connected to device 402B by edge 404B, and device 402B is connected to device 402C by edge 404C. An operator of these computing devices may represent this network flow as an optimization problem in order to optimize network traffic latency, throughput, cost, or some other objective.

FIG. 5A illustrates a network flow graph of the traffic engineering problem depicted in FIG. 4. The disclosed intermediate representation allows a user to encode optimization problem 102 as network flow graph 108. FIG. 5A illustrates three types of nodes: input nodes, choice nodes, and output nodes. Normal arrows originate from input nodes, bolded arrows originate from choice nodes, and dotted arrows originate from output nodes.

Input nodes are sources of network flow. Input nodes represent problem inputs, such as demands between pairs in traffic engineering and item sizes in bin packing. One type of input node is a source node. Source nodes are nodes without incoming arcs, and whose incoming flow can be any amount for the purposes of satisfying flow conservation.

Choice nodes are non-source nodes that direct flow through the graph. They represent choices the heuristic makes, such as where to direct network traffic in traffic engineering and where to place items in bin packing. Some example types of choice nodes include split nodes, pick nodes, copy nodes, and order nodes. Split nodes split incoming flow arbitrarily among outgoing arcs. Pick nodes send incoming flow to one outgoing arc. Copy nodes send incoming flow to each outgoing arc. Order nodes send incoming flow to an ordered sequence of arcs: flow is sent to the first outgoing arc, then if there is remaining flow to the second outgoing arc, etc.

Output nodes are all other nodes. They represent constraints and objectives in the problem. One constraint in traffic engineering is edge capacity, representing the bandwidth of a particular network link. One objective in traffic engineering is “meeting path demands,” establishing that demands placed on a path are met by the capacities of the underlying network links. In bin packing, one constraint is bin size while one objective is minimizing the number of bins used.

Sink nodes are output nodes without outgoing arcs. Sink nodes do not have flow conservation rules, but do have one or more objectives. Maximize/minimize sinks have as objectives making their incoming flow as high/low as possible, respectively. Maximize/minimize nonzero sinks have as objectives having as many/few arcs with nonzero flow as possible, respectively. Ignored sinks do not have an associated objective.

The nodes of FIG. 5A are arranged in layers for ease of description, but this arrangement is not limiting and does not affect the operation of the graph. The first layer contains split node 502, an input node from which flow originates. The second layer contains choice nodes representing pairs of computing devices 402 in the traffic engineering diagram of FIG. 4. In this example, ‘split’ nodes 504 represent a choice to split incoming flow among one or more outgoing arcs.

Path nodes 506 are output nodes that represent network paths composed of one or more edges 404 that traffic may be routed through. Unmet path demand 510 is a minimization sink that accepts unmet demand. In some configurations, compiler 210 will generate an objective to minimize the flow received by this minimization sink, effectively maximizing flow that is directed through path nodes 506. In this example, path nodes 506 are successor nodes of choice nodes 504 because they are recipients of flow yielded by choice nodes 504. In general, any node that receives flow from a particular node is considered a successor node of that particular node.

Each solution, such as heuristic 104 or benchmark solution 106, computes flow percentages 505 for each outgoing arc of a particular node. In some configurations, flow percentages must account for all incoming flow to a particular node. In other configurations, remaining flow may be shunted to a sink such as unmet path demand 510. In still other configurations, some flow may be reserved for additional optimizations.

Output nodes 508 represent network connections between individual pairs of computing devices 402. Arcs 518 connect edges 508 to sink 512. Each arc 518 is decorated with a capacity 520 that reflect the network capacities of edges 404.

FIG. 5B illustrates a heatmap of heuristic 104. In this illustration, line thickness correlates with the number of times an arc was traversed by heuristic 104. Specifically, gap inputs 112, which were generated by heuristic analyzer 520 of heuristic analysis engine 510, are provided as inputs with heuristic 104 to heuristic analysis engine 110. While inputs 112 are evaluated using heuristic 104, a tally is made each time an arc of network flow graph 108 is traversed. Larger tallies are indicated in the heat map with thicker arcs.

FIG. 5C illustrates a heatmap of benchmark solution 106. Similar to FIG. 5B, arc thickness represents how often an arc was utilized while evaluating an input-typically one of inputs 112.

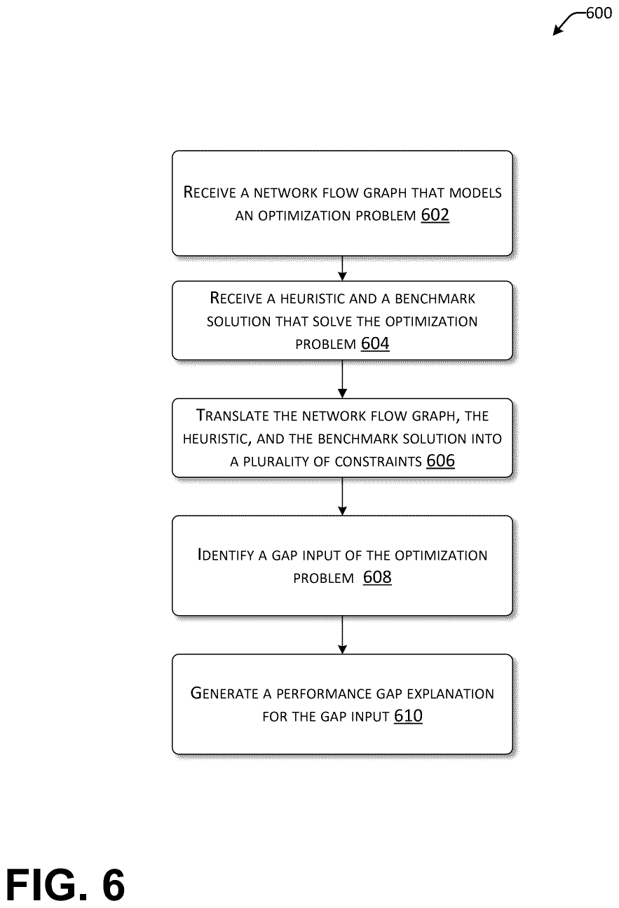

FIG. 6 is a flow diagram of an example method for flow network intermediate representation for optimization problems. Routine 600 begins at operation 602, where a network flow graph 108 that models an optimization problem 102 is received.

Next at operation 604, a heuristic 104 and a benchmark solution 106 that solve the optimization problem 102 are received.

Next at operation 606, the network flow graph 108, the heuristic 104, and the benchmark solution 106 are translated into a plurality of constraints 204 that are compatible with heuristic analyzer 220.

Next at operation 608, gap input 112 is identified that results in heuristic 104 underperforming benchmark solution 106. In some configurations, multiple gap inputs 112 are identified. A heatmap is generated by evaluating the heuristic 104 and the benchmark solution 106 for the plurality of gap inputs and noting which arcs 518 of network flow graph 102 were taken by the different solutions.

Next at operation 610, performance gap explanation 122 is generated for gap input 112. Performance gap explanation may use a large language model or procedural code to extract insights about choices made by the different solutions. These different choices, and the inputs that lead to the different choices, may be included in gap explanation 122. This enables a user to identify why heuristic 104 has underperformed in terms of network flow graph 108.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated methods can end at any time and need not be performed in their entireties. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine 600 is described herein as being implemented, at least in part, by modules running the features disclosed herein can be a dynamically linked library (DLL), a statically linked library, functionality produced by an application programing interface (API), a compiled program, an interpreted program, a script or any other executable set of instructions. Data can be stored in a data structure in one or more memory components. Data can be retrieved from the data structure by addressing links or references to the data structure.

Although the following illustration refers to the components of the figures, it should be appreciated that the operations of the routine 600 may be also implemented in many other ways. For example, the routine 600 may be implemented, at least in part, by a processor of another remote computer or a local circuit. In addition, one or more of the operations of the routine 600 may alternatively or additionally be implemented, at least in part, by a chipset working alone or in conjunction with other software modules. In the example described below, one or more modules of a computing system can receive and/or process the data disclosed herein. Any service, circuit or application suitable for providing the techniques disclosed herein can be used in operations described herein.

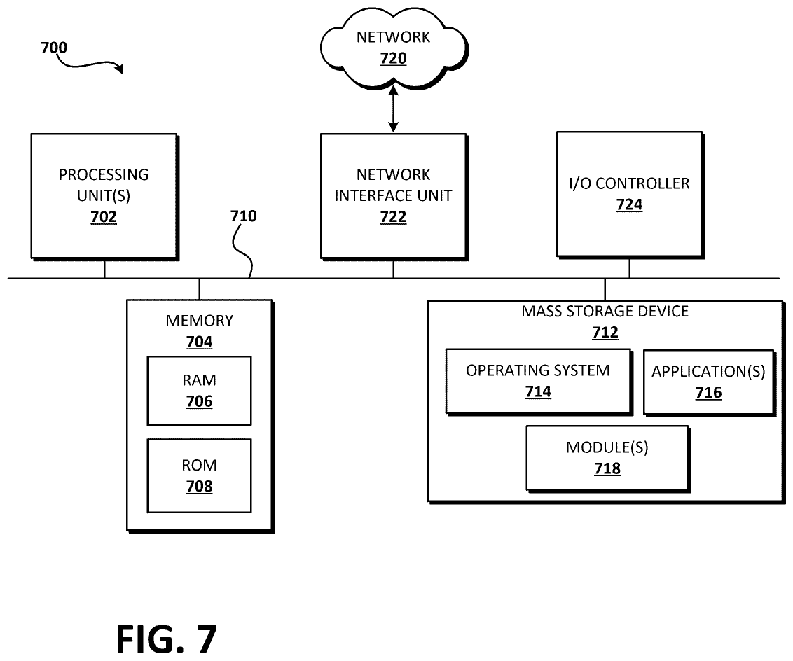

FIG. 7 shows additional details of an example computer architecture 700 for a device, such as a computer or a server configured as part of the systems described herein, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a neural processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), Neural Processing Unites (NPUs) etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

The present disclosure is supplemented by the following example clauses:

Example 1: A method comprising: receiving a network flow graph that models an optimization problem, wherein the network flow graph comprises a plurality of nodes connected by a plurality of arcs, and wherein a choice node of the plurality of nodes is connected to a plurality of successor nodes; receiving a heuristic that solves the optimization problem, wherein the heuristic programmatically determines a first flow percentage sent from the choice node to one of the plurality of successor nodes; receiving a benchmark solution that solves the optimization problem, wherein the benchmark solution programmatically determines a second flow percentage sent from the choice node to the one of the plurality of successor nodes; translating the network flow graph, the heuristic, and the benchmark solution into a plurality of constraints; identifying a gap input of the optimization problem that results in a performance gap between the heuristic and a benchmark solution of the optimization problem by solving the plurality of constraints; and generating a performance gap explanation for the gap input that refers to the plurality of nodes.

Example 2: The method of Example 1, further comprising: identifying a heuristic arc of the plurality of arcs that is traversed while evaluating the heuristic with the gap input but that is not traversed when evaluating the benchmark solution with the gap input; identifying the choice node that caused the heuristic to direct flow to the heuristic arc, wherein the performance gap explanation refers to the choice node.

Example 3: The method of Example 2, further comprising: identifying the gap input as causing the heuristic to underperform the benchmark solution.

Example 4: The method of Example 1, further comprising: adding a constraint to the plurality of constraints that a value of an input of the optimization problem remains the same for the heuristic and the benchmark solution.

Example 5: The method of Example 1, further comprising: adding a no previous solution constraint to the plurality of constraints that prevents a previously identified gap input from being identified again; identifying a plurality of gap inputs by iteratively generating an individual gap input and updating the no previous solution constraint to include the individual gap input; evaluating the heuristic and the benchmark solution with the plurality of gap inputs; identifying different choices made by the heuristic and the benchmark solution based on arcs predominantly taken by the heuristic or the benchmark solution.

Example 6: The method of Example 5, wherein the heuristic and the benchmark solution are evaluated with inputs proximate to inputs of the plurality of gap inputs.

Example 7: The method of Example 1, wherein the heuristic includes a flow function that assigns flow values to outgoing arcs of individual nodes of the network flow graph and a weight function that determines a node visitation order.

Example 8: A computer-readable storage medium having computer-executable instructions stored thereupon that, when executed by a processing system, cause the processing system to: receive a network flow graph that models an optimization problem, wherein the network flow graph comprises a plurality of nodes connected by a plurality of arcs, wherein a choice node of the plurality of nodes models a choice made by an algorithm solving the optimization problem by restricting how flow leaves the choice node, and wherein an output node of the plurality of nodes includes a flow capacity that models an aspect of the optimization problem; translating the network flow graph into a plurality of constraints and an objective function; modeling how a heuristic solves the optimization problem by determining how flow flows through the network flow graph; and identifying a gap input that results in a performance gap between the heuristic and a benchmark solution of the optimization problem.

Example 9: The computer-readable storage medium of Example 8, wherein the choice node comprises a pick node that directs incoming flow to one outgoing arc of the pick node.

Example 10: The computer-readable storage medium of Example 8, wherein the choice node comprises an order node that directs incoming flow in turn to a sequence of outgoing arcs of the order node.

Example 11: The computer-readable storage medium of Example 8, wherein an output node of the plurality of nodes represents an objective of the optimization problem.

Example 12: The computer-readable storage medium of Example 8, wherein the plurality of nodes includes an input node that represents an input of the optimization problem.

Example 13: The computer-readable storage medium of Example 8, wherein an arc of the plurality of arcs is associated with metadata usable to explain the performance gap.

Example 14: The computer-readable storage medium of Example 8, wherein the benchmark solution comprises an optimal solution, wherein the performance gap is identified by applying a bi-level optimization that holds inputs consistent between the heuristic and the benchmark solution.

Example 15: A processing system, comprising: a processor; and a computer-readable storage medium having computer-executable instructions stored thereupon that, when executed by the processor, cause the processing system to: receive a network flow graph that models an optimization problem, wherein the network flow graph comprises a plurality of nodes connected by a plurality of arcs, wherein a choice node of the plurality of nodes models a choice made by an algorithm solving the optimization problem by restricting how flow leaves the choice node, and wherein an output node of the plurality of nodes includes a flow constraint that models an aspect of the optimization problem; translating the network flow graph into a plurality of constraints; modeling how a heuristic solves the optimization problem by determining how flow flows through the network flow graph; and identifying a performance gap between the heuristic and a benchmark solution of the optimization problem.

Example 16: The processing system of Example 15, wherein modeling how the heuristic solves the optimization problem comprises assigning flow percentages to one or more outgoing arcs of the choice node.

Example 17: The processing system of Example 16, wherein the heuristic defines a flow function that assigns the flow percentages to the one or more outgoing arcs of the choice node, and wherein the flow function has access to intrinsic functions that obtain an amount of incoming flow of an individual choice node, an available capacity of an outgoing arc of the individual choice node, or a list of outgoing arcs of the individual choice node.

Example 18: The processing system of Example 17, wherein the assignment function includes a relational query over arc sequences usable when assigning the flow percentages, and wherein the relational query is translated into at least one constraint of the plurality of constraints.

Example 19: The processing system of Example 18, wherein the relational query filters arc sequences based on a condition.

Example 20: The processing system of Example 18, wherein the relational query is defined using a declarative query syntax that is integrated into a programming language for data manipulation.

While certain example embodiments have been described, these embodiments have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated that any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a network flow graph that models an optimization problem, wherein the network flow graph comprises a plurality of nodes connected by a plurality of arcs, and wherein a choice node of the plurality of nodes is connected to a plurality of successor nodes;
receiving a heuristic that solves the optimization problem, wherein the heuristic programmatically determines a first flow percentage sent from the choice node to one of the plurality of successor nodes;
receiving a benchmark solution that solves the optimization problem, wherein the benchmark solution programmatically determines a second flow percentage sent from the choice node to the one of the plurality of successor nodes;
translating the network flow graph, the heuristic, and the benchmark solution into a plurality of constraints;
identifying a gap input of the optimization problem that results in a performance gap between the heuristic and a benchmark solution of the optimization problem by solving the plurality of constraints; and
generating a performance gap explanation for the gap input that refers to the plurality of nodes.

2. The method of claim 1, further comprising:
identifying a heuristic arc of the plurality of arcs that is traversed while evaluating the heuristic with the gap input but that is not traversed when evaluating the benchmark solution with the gap input;
identifying the choice node that caused the heuristic to direct flow to the heuristic arc, wherein the performance gap explanation refers to the choice node.

3. The method of claim 2, further comprising:
identifying the gap input as causing the heuristic to underperform the benchmark solution.

4. The method of claim 1, further comprising:
adding a constraint to the plurality of constraints that a value of an input of the optimization problem remains the same for the heuristic and the benchmark solution.

5. The method of claim 1, further comprising:
adding a no previous solution constraint to the plurality of constraints that prevents a previously identified gap input from being identified again;
identifying a plurality of gap inputs by iteratively generating an individual gap input and updating the no previous solution constraint to include the individual gap input;
evaluating the heuristic and the benchmark solution with the plurality of gap inputs;
identifying different choices made by the heuristic and the benchmark solution based on arcs predominantly taken by the heuristic or the benchmark solution.

6. The method of claim 5, wherein the heuristic and the benchmark solution are evaluated with inputs proximate to inputs of the plurality of gap inputs.

7. The method of claim 1, wherein the heuristic includes a flow function that assigns flow values to outgoing arcs of individual nodes of the network flow graph and a weight function that determines a node visitation order.

8. A computer-readable storage medium having computer-executable instructions stored thereupon that, when executed by a processing system, cause the processing system to:
receive a network flow graph that models an optimization problem, wherein the network flow graph comprises a plurality of nodes connected by a plurality of arcs, wherein a choice node of the plurality of nodes models a choice made by an algorithm solving the optimization problem by restricting how flow leaves the choice node, and wherein an output node of the plurality of nodes includes a flow capacity that models an aspect of the optimization problem;
translating the network flow graph into a plurality of constraints and an objective function;
modeling how a heuristic solves the optimization problem by determining how flow flows through the network flow graph; and
identifying a gap input that results in a performance gap between the heuristic and a benchmark solution of the optimization problem.

9. The computer-readable storage medium of claim 8, wherein the choice node comprises a pick node that directs incoming flow to one outgoing arc of the pick node.

10. The computer-readable storage medium of claim 8, wherein the choice node comprises an order node that directs incoming flow in turn to a sequence of outgoing arcs of the order node.

11. The computer-readable storage medium of claim 8, wherein an output node of the plurality of nodes represents an objective of the optimization problem.

12. The computer-readable storage medium of claim 8, wherein the plurality of nodes includes an input node that represents an input of the optimization problem.

13. The computer-readable storage medium of claim 8, wherein an arc of the plurality of arcs is associated with metadata usable to explain the performance gap.

14. The computer-readable storage medium of claim 8, wherein the benchmark solution comprises an optimal solution, wherein the performance gap is identified by applying a bi-level optimization that holds inputs consistent between the heuristic and the benchmark solution.

15. A processing system, comprising:
a processor; and
a computer-readable storage medium having computer-executable instructions stored thereupon that, when executed by the processor, cause the processing system to:
receive a network flow graph that models an optimization problem, wherein the network flow graph comprises a plurality of nodes connected by a plurality of arcs, wherein a choice node of the plurality of nodes models a choice made by an algorithm solving the optimization problem by restricting how flow leaves the choice node, and wherein an output node of the plurality of nodes includes a flow constraint that models an aspect of the optimization problem;
translating the network flow graph into a plurality of constraints;
modeling how a heuristic solves the optimization problem by determining how flow flows through the network flow graph; and
identifying a performance gap between the heuristic and a benchmark solution of the optimization problem.

16. The processing system of claim 15, wherein modeling how the heuristic solves the optimization problem comprises assigning flow percentages to one or more outgoing arcs of the choice node.

17. The processing system of claim 16, wherein the heuristic defines a flow function that assigns the flow percentages to the one or more outgoing arcs of the choice node, and wherein the flow function has access to intrinsic functions that obtain an amount of incoming flow of an individual choice node, an available capacity of an outgoing arc of the individual choice node, or a list of outgoing arcs of the individual choice node.

18. The processing system of claim 17, wherein the assignment function includes a relational query over arc sequences usable when assigning the flow percentages, and wherein the relational query is translated into at least one constraint of the plurality of constraints.

19. The processing system of claim 18, wherein the relational query filters arc sequences based on a condition.

20. The processing system of claim 18, wherein the relational query is defined using a declarative query syntax that is integrated into a programming language for data manipulation.
